(19) United States
(12) Patent Application Publication
(10) Pub. No.: US 2023/0356448 A1
(43) Pub. Date: Nov. 9, 2023

(54) SYSTEM AND METHOD FOR EXTRUDING COMPLEX PROFILES FROM ELASTOMER MIXTURES

(71) Applicant: Compagnie Generale Des Etablissements Michelin, Clermont-Ferrand (FR)

(72) Inventors: Henri HINC, Clermont-Ferrand (FR); Arnaud Letocart, Clermont-Ferrand (FR); Christophe Ougier, Clermont-Ferrand (FR)

(21) Appl. No.: 18/224,684

(22) Filed: Jul. 21, 2023

Related U.S. Application Data
(63) Continuation of application No. 17/054,220, filed on Nov. 10, 2020.

(30) Foreign Application Priority Data
May 14, 2018 (FR) 1854016

(51) Int. Cl. B29C 48/49; B29C 48/455; B29C 48/375; B29C 48/21; B29C 48/12

(52) U.S. Cl. CPC B29C 48/49; B29C 48/455; B29C 48/387; B29C 48/21; B29C 48/388; B29C 48/12; B29K 2021/003

(57) ABSTRACT

The extrusion installation is configured for manufacturing a complex profiled-element strip, such as a tread, based on elastomer compounds by co-extrusion, and comprises multiple extruders feeding elastomer compounds to an extrusion head. The extrusion head receives a proportion of elastomer compound of between 2 and 25% of the total volumetric throughput of the installation from at least one Archimedean-screw extruder and the rest from positive-displacement extruders.

### CROSS-REFERENCE TO RELATED APPLICATIONS

This Continuation Application claims priority to and the benefit of U.S. patent application Ser. No. 17/054,220, filed Nov. 10, 2020, entitled “SYSTEM AND METHOD FOR EXTRUDING COMPLEX PROFILES FROM ELASTOMER MIXTURES”; to PCT Patent Application No. PCT/FR2019/051071, filed May 13, 2019, entitled “SYSTEM AND METHOD FOR EXTRUDING COMPLEX PROFILES FROM ELASTOMER MIXTURES”; and to French Patent Application No. 1854016 filed May 14, 2018 entitled “SYSTEM AND METHOD FOR EXTRUDING COMPLEX PROFILES FROM ELASTOMER MIXTURES”.

### BACKGROUND

### 1. Field

The disclosure relates to the field of the extrusion of elastomer compounds intended for the manufacture of tires. More particularly, it relates to the manufacture of co-extruded complex profiled elements based on elastomer compounds, such as tire treads.

### 2. Related Art

In the known way, a tire tread is produced in the form of a complex profiled element by co-extruding elastomer compounds, most of which have different compositions, using multiple extruders connected to a common extrusion head. In the known way, an extruder is formed of a cylindrical body or barrel which is stationary, and inside which there is an Archimedean screw that is coaxial with the longitudinal axis of the barrel and driven in rotation about this axis. Its purpose is to homogenize a rubber compound introduced into it and to drive it towards the outlet die of the extrusion head. In the case of a complex product, the outlet die receives multiple elastomer compounds of different compositions arranged side-by-side and which come together before the outlet. The die comprises an outlet orifice the geometric shape of which determines the profile of the co-extruded rubber strip. This profile can be defined between a fixed profiled blade which collaborates with a rotary roller or with a fixed wall.

In order to manufacture a tread using co-extrusion, use is generally made of one extruder per type of elastomer compound (what is meant by type is the composition of said compound), the dimensions of the extruder (the diameter of the extrusion screw) being chosen in proportion to the volume of compound extruded. For example, in the case of a tread of which the external part intended for running on represents 80% of the volume and to which is added a sublayer representing approximately 15% of the volume and two lateral edges together representing the remaining 5%, use is generally made of three extruders: a larger first one of which the screw diameter is 250 mm, a second one, for the sublayer, having a screw diameter of 200 mm, and a small third extruder having a diameter of 120 mm.

There is now a drive to improve tire performance by using more complex treads which contain an even greater number of components, for example up to seven different components, with very variable volume proportions between the various components. Each component has its own clearly defined properties, for example the tread portion situated on the outside of the profiled strip comprises an elastomer composition containing silica which has good rolling resistance properties, supported by a strip of elastomer of a different composition having shock-absorbing properties, with a small strip of a conductive elastomer compound which is inserted into the previous two strips, all of this supported by a sublayer that has good properties of adhesion to the components situated radially on the inside of the green tire, as well as lateral edges made from a compound different from the previous ones, or even a compound that incorporates mixed offcuts. Thus, because each compound has different properties from another, it is obviously necessary to increase the number of extruders in order to manufacture such a complex tread. In the case of complex treads, it is difficult to master the geometry of the product leaving the extrusion die, because each path (each extruder) is calibrated to its own operating parameters (notably in terms of the supplied flow rate and pressure), but these parameters vary as the mixture passes through the common die, as a function of parameters of the extruders that are feeding into the other paths. This results, on the one hand, in a fairly lengthy time required to bring the installation into service and, on the other hand, in scrap which is furthermore in the form of mixed offcuts, which, being mixed, are therefore difficult to reuse.

In order to alleviate this problem, patent application WO2017/109419 in the name of the Applicant proposes an extrusion installation for creating a tread which uses positive-displacement counter-rotating twin-screw extruders with intermeshing screw flights with mating profiles. When such positive-displacement twin-screw extruders are used on each of the paths of the installation, it becomes possible to control the flow rate and, therefore, the geometry of the product right from the very start of the coextrusion operation. Although this operates satisfactorily, it has however been found that such an installation soon becomes complex when the number of paths is high, for example greater than four.

### SUMMARY

One objective of the disclosure is to overcome the drawbacks recalled herein and to propose an extrusion installation of optimized and economical construction, while at the same time making it possible to obtain a good-quality co-extruded product.

This objective is achieved by the disclosure, which proposes an extrusion installation for the manufacture of a strip of a profiled element, such as a tread, based on elastomer compounds by co-extrusion, and comprising multiple extruders feeding elastomer compounds to an extrusion head, wherein the extrusion head receives a proportion of elastomer compound of between 2 and 25% of the total volumetric throughput of the installation from at least one Archimedean-screw extruder, and the rest from a positive-displacement extruders.

What is meant by the total volumetric throughput of the installation is the volume of material that passes through the extrusion head (which comprises the outlet die) in a given space of time. Several different compounds, each having specific physical-chemical properties, constitute the products which, in variable proportions, are involved in the make up of a complex tread. The volume occupied by each of these products with respect to the total volume of the tread varies according to the recipe selected. According to the disclosure, the extrusion head is fed directly from Archimedean-screw extruders, which are not positive-displacement extruders, in respect of a small proportion of the volumetric throughput of the extrusion head, preferably less than 25% of the total volume. The installation also comprises positive-displacement extruders to feed the extrusion head directly with the majority of the volumetric throughput of elastomer compounds of the same head, notably in respect of the remaining volume which represents at most 75% of the total volumetric throughput of the head.

This makes it possible to obtain rapid control of the throughput right from the very start-up of the installation, for a compact construction thereof. Indeed, the volumetric throughput of the non-positive-displacement paths is low in comparison with the total volumetric throughput and, even if there are variations in the throughput coming from the non-positive-displacement paths, that variation is negligible, making it possible to obtain an extruded strip that is correctly dimensioned, and is so right from the very start of the run. Furthermore, non-positive-displacement extruders are of simpler construction and occupy less space because they comprise a fairly low number of components (in comparison with positive-displacement extruders) and have nominal dimensions (diameter and length of the extrusion screw) which are small because they are linked directly to the low throughput that the extruder is to supply.

As a preference, the flights of the screw of the Archimedean-screw extruder are shallow, the height of the flight being less than 0.2 the value of the diameter of the screw, for a short pitch, the value of which is less than 1.5 the value of the diameter of the screw. Such an extruder of optimized geometry allows better control over the throughput.

As a further preference, the length of the screw of the Archimedean-screw extruder is greater than 8 times the value of its diameter. This makes it possible to obtain a stabilized, and therefore better controlled, throughput.

Advantageously, the positive-displacement extruders are positive-displacement counter-rotating twin-screw extruders with intermeshing screw flights with mating profiles. Such positive-displacement extruders ensure a throughput that is controlled and constant over time, while at the same time having a compactness that makes them compatible with a coextrusion installation.

As a preference, the extrusion head comprises ducts for distributing the elastomer compounds coming from the extruders toward an outlet die, and the Archimedean-screw extruder is connected to the outlet die by a duct of a length less than that of the distribution ducts of the other extruders. The distribution duct that connects the outlet die to the Archimedean-screw extruder is thinner (its cross-sectional area being far smaller than that of the positive-displacement paths) and its location close to the outlet makes it possible to reduce the value of the thrusting pressure that the Archimedean-screw extruder has to apply and to thus optimize pressure drops.

Advantageously, the distribution ducts extend in a direction substantially perpendicular to the direction in which the flows of elastomer compounds coming from said extruders flow. Such a solution makes it possible to achieve better cohesion between the two compounds and avoid any problem with the interfacing between them.

As a preference, the extruders are arranged on either side of the head with respect to a plane of symmetry passing through the outlet orifice of the die. This solution allows better balancing of the flows coming from the various extruders.

Advantageously, the extrusion head is connected directly to the extruders without there being any elastomer-compound transfer duct between the two. Thus, the end of the screw of each extruder substantially reaches the corresponding inlet orifice in the extrusion head, and this greatly reduces the pressure drop. The remaining volume can thus be used to create, in the extrusion head, inlet ducts that are wider than those of the extruders of the prior art, thereby making it possible to reduce the extent to which the compound is heated, and increase the productivity of the machine.

Preferably, the Archimedean-screw extruders are identical and the positive-displacement extruders are identical to one another. The maintenance of the installation is thus made easier.

Advantageously, the extrusion head comprises an assembly of several removable plates positioned side by side. Such a construction involving removable plates makes it possible to obtain an extrusion head that is of simplified and flexible construction.

The objective of the disclosure is also achieved with a method for the manufacture of a strip of a profiled element, such as a tread, based on elastomer compounds by co-extrusion, using an installation comprising multiple extruders feeding elastomer compounds to an extrusion head, wherein a proportion of between 2 and 25% of the total volumetric throughput of the installation, coming from at least one Archimedean-screw extruder, and the rest coming from positive-displacement extruders, are passed simultaneously through the extrusion head.

### BRIEF DESCRIPTION OF DRAWINGS

The disclosure will be understood better from the rest of the description, which is supported by the following figures:

FIG. 1 is a perspective view of one example of a tread obtained using the installation of the disclosure;

FIG. 2 is a schematic perspective view of the extrusion installation of the disclosure; and

FIG. 3 is a schematic view in longitudinal section of the installation of FIG. 2.

In the various figures, elements that are identical or similar bear the same reference. Their description is therefore not systematically repeated.

### DETAILED DESCRIPTION OF THE ENABLING EMBODIMENT

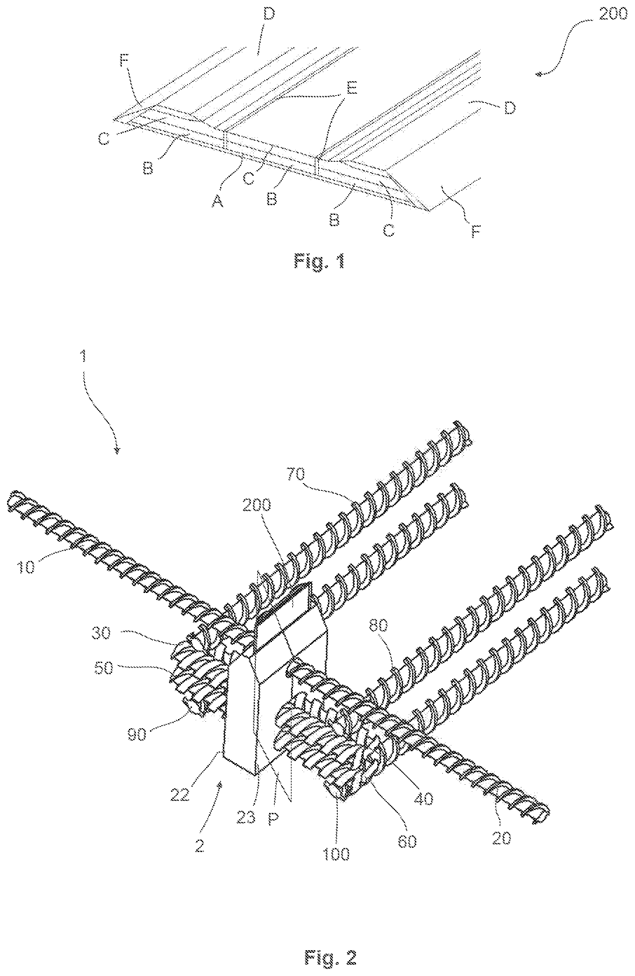

FIG. 1 illustrates a complex profiled-element strip 200, such as a tread for a tire, produced from several elastomer compounds in order to create the various components A, B, C, D, E and F of the tread. The various compounds arrive from the plurality of extruders 10, 20, 30, 40, 50 and 60 belonging to an extrusion installation 1 (FIG. 2), which compounds converge on one another in a common extrusion head 2 to create, by coextrusion, a complex profiled-element strip 200. The complex profiled-element strip 200 is, in the example of FIG. 1, a tread for a tire. It comprises a sublayer A and an adjacent layer B situated on top of it, and an external layer C. Two end profiled elements D complete the external layer C, which additionally comprises two conducting inserts E. The assembly is finally completed by two lateral edges F.

Such elastomer compounds for creating a tread are, by way of example, compounds based on elastomers or rubber which are used to create a tread assembly, such as: a first material made 100% of natural rubber, to create a sublayer A, then a second material which is made 100% of a synthetic rubber, for example containing silica, to create the external part C of the tread, and a third material not containing silica but having absorbent properties, to form an intermediate layer B, followed by a fourth and a fifth material to create the end parts D and the lateral edges F and made up for example of a compound of natural/synthetic rubber (containing 20% to 80% natural rubber), and a sixth material E which is a conductive compound containing a mixture of natural/synthetic rubber and carbon black.

According to the disclosure, the extrusion head 2 of the extrusion installation of the disclosure receives a proportion of elastomer compound of between 2 and 25% of the total volumetric throughput of the installation from non-positive-displacement extruders 10 and 20 which are of the Archimedean-screw extruder type, and the rest from positive-displacement extruders 30, 40, 50 and 60. The Archimedean-screw extruders 10, 20 comprise a screw which rotates inside a barrel coaxial with the screw, rotationally driven by a geared motor unit. They are more compact in bulk and simpler in construction in comparison with the positive-displacement extruders 30, 40, 50 and 60. Furthermore, a complex tread is made up of products in very small volume, notably the conducting insert E and the lateral flanks F of the tread illustrated in FIG. 1. The proportion that the volume of these components represents in comparison with the volume of all of the components of the tread or, in other words, the volumetric fraction of the components E and F within the profiled-element strip 200 which incorporates the components A to F, is comprised between 2 and 25%. Such a volumetric fraction is therefore very small in comparison with the total volume of the strip. Now, given that the components that occupy most of the volume of the strip (between 75 and 98%) are supplied by positive-displacement extruders the throughput of which is controlled with precision, the result is that the variation in the throughput of the extruders supplying components E and F does not lead to very significant variations in the total volume of the complex profiled-element strip 200. This then yields an extrusion installation 1 which is compact and less bulky and which at the same time makes it possible to obtain a co-extruded profiled-element strip of fairly precise dimensions.

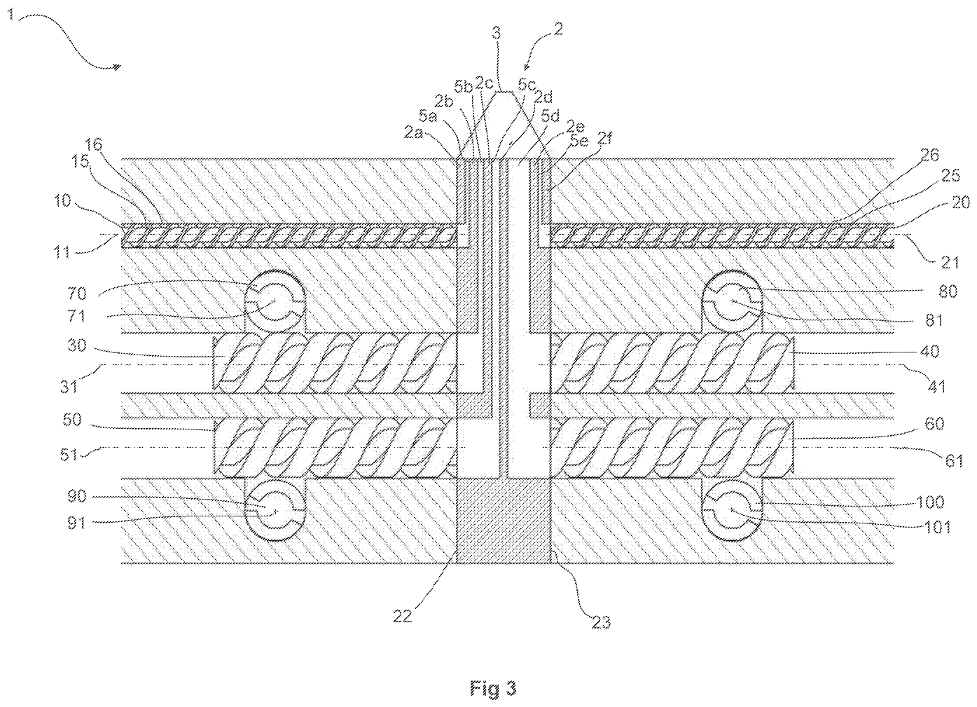

According to one advantageous aspect of the disclosure, the Archimedean-screw extruders 10, 20 are dimensioned in such a way that their operational throughput is as constant as possible. As is best visible in FIGS. 2 and 3, the extruder 10, 20 comprises a screw 15, 25 which rotates about an axis 11, 21 inside a barrel 16, 26, driven by a geared motor unit (not depicted). The dimensions of the screws 15, 25 are designed so that their screw flights are shallow and so that the pitches of the screws are fairly short. Thus, the screw flight of each screw 15, 25, has a height less than 0.2 times the diameter of the screw and a short pitch, preferably less than 1.5 times the diameter of the screw. The length of each screw 15, 25 is chosen so that it is greater than 8 times the diameter of the screw.

FIG. 2 illustrates an extrusion installation 1 of the disclosure, comprising multiple extruders 10, 20, 30, 40, 50, 60 for creating a profiled product, by co-extrusion, in a common extrusion head 2. The profiled product obtained is a tread 200 and comprises multiple components, six in the example illustrated, produced from elastomer materials coming from different extruders. The extruders 10, 20, 30, 40, 50, 60 have been illustrated schematically, depicting only their respective screws, but it will be appreciated that, in a way that is generally known, the screw of each extruder rotates inside a barrel equipped with an elastomer-compound feed inlet and with an outlet which opens into the extrusion head 2. The extruders 10 and 20 are of the Archimedean-screw type, as previously described, whereas the extruders 30, 40, 50 and 60 are positive-displacement counter-rotating twin-screw extruders with intermeshing screw flights with mating profiles. Each positive-displacement extruder comprises two parallel screws rotating in contrary directions inside a barrel of figure-eight cross section, so as to form C-shaped sealed chambers with the interior walls of said barrel. Each positive-displacement extruder is fed by a feed extruder 70, 80, 90, 100 which is an extruder of the Archimedean-screw type of axis 71, 81, 91, 101 each perpendicular to respective axis 31, 41, 51, 61 of the positive-displacement extruder screws. Such positive-displacement extruders are of the type described in patent application WO2017/109419 in the name of the Applicant.

The extruders 10, 20, 30, 40, 50, 60 are arranged on each side of the extrusion head 2 and the longitudinal axes of the screws 10, 20 and the central axis of each of the positive-displacement extruders 30, 40, 50, 60 (what is meant by central axis is an axis parallel to the longitudinal axis of the screws of the twin-screw extruder and passing through the center of the outlet opening of said extruder) are situated in the plane of symmetry P of the tread 200. The plane of symmetry P is a vertical plane that passes through the center of gravity of the strip, when the product is a symmetrical product or, in the case of an asymmetric product, through the center of inertia thereof. What is meant by extruders situated on either side of the extrusion head is extruders facing one another by being arranged on either side of a vertical plane perpendicular to the plane of symmetry P and passing through the center of the extrusion head 2. Such an arrangement makes it possible to balance the flows from the various extruders that pass through the extrusion head. In a variant (not illustrated in the drawings), the various extruders are arranged on either side of the extrusion head 2 without their respective longitudinal axes lying in the plane of symmetry P. In yet another variant, certain extruders are arranged on the sides of the extrusion head 2, or even in the opposite part to the outlet-die part thereof.

In operation, when each extruder is fed with an elastomer compound, the various compounds extruded by the extruders 10, 20, 30, 40, 50 and 60 pass along the distribution ducts provided for that purpose in the extrusion head 2 without mixing and converge towards a die 3 which gives the product, in this instance the tread 200, its final shape.

In the example illustrated in the figures, the extruders 10, 20, 30, 40, 50, 60 are arranged with their longitudinal axes 11, 21, 31, 41, 51, 61 mutually parallel, and perpendicular to the lateral walls 22, 23 of the extrusion head 2, three extruders 10, 30 and 50 being situated to the right of the vertical midplane of the extrusion head and the other three 20, 40 and 60 to the left of this plane. The extruders on the right and those on the left face one another; they are situated in pairs at one and the same height, their longitudinal axes being situated in one and the same plane. However, the extruders on the right could be arranged at a different height from those on the left. In a variant, the longitudinal axes of the extruders are not parallel, but at an angle to one another, it being possible for the angle formed by the longitudinal axes of two adjacent extruders to differ from that formed by the longitudinal axes of two other adjacent extruders. In yet another variant, it is possible to envisage a different number of extruders on the right compared with those situated on the left of the head.

The extrusion head 2 is made up of a stack of several plates, six in the example illustrated in FIG. 5: 2a, 2b, 2c, 2d, 2e, 2f parallel to one another and parallel to the lateral walls 22, 23 of the extrusion head and perpendicular to the longitudinal axes of the extruders 10, 20, 30, 40, 50, 60. The plates 2a to 2f have a length equal to or slightly smaller than that of the lateral walls 22, 23 of the head and between them define transverse distribution ducts 5a, 5b, 5c, 5d, 5e which carry the elastomer compound coming from the extruders of the installation towards the outlet die 3. The plates 2a to 2f are removable and are held together and attached to the lateral walls of the extrusion head for example by a screw-fixing (not depicted). The installation of FIG. 2 is able to create the six-component tread 200 of FIG. 1.

In the example illustrated in FIG. 3, the extrusion head comprises a distribution duct 5d which is common to the extruders 40 and 50.

According to one advantageous aspect of the disclosure, the extrusion head 2 is interchangeable and is connected directly to the extruders 10, 20, 30, 40, 50, 60 without there being any elastomer-compound transfer duct between the two. Thus, the choice of making two extruders collaborate with one another is made by fitting the appropriate extrusion head, and then in operating the extruders according to the geometry of the product that is to be obtained. The quantity of product sent to the die is regulated by adjusting the rotational speed of the extruder screws. Furthermore, the extruders 10, 20, 30, 40, 50, 60 deliver directly into the extrusion head 2, thereby markedly limiting the pressure drops.

According to another advantageous aspect of the disclosure, the Archimedean-screw extruders 10, 20 are identical to one another and the positive-displacement extruders 30, 40, 50, 60 are identical to one another. The maintenance of the installation is thus made easier.

Furthermore, a “facing one another” arrangement is advantageous because it reduces the size of the dimensional tooling, notably of the extrusion head, providing for better ergonomics and at the same time making it possible to reduce the weight of same.

In operation, an extrusion head 2 fitted with a die 3 able to create a complex tread 200, based on multiple elastomer compounds of different compositions by co-extrusion of elastomer compounds originating from the extruders 10, 20, 30, 40, 50, 60 is selected and introduced into a support provided for that purpose in the installation 1. The extrusion head is locked in place using the quick-fit means (which are not illustrated in the figures). The extrusion operation is performed.

Other variants and embodiments of the disclosure can be envisaged without departing from the scope of its claims.

Thus, more than six extruders can be arranged on either side of the extrusion head, or even on the other faces of the extrusion head that are not assigned, one to the outlet of the compounds towards the extrusion die and the other to the grasping of the head so that it can be moved around, at least two of them working with different compounds and certain others working with one and the same elastomer compound.

Moreover, it is possible to use other types of positive-displacement extruders, for example of the geared pump or piston pump type.

What is claimed is:

1. A method of making a strip of a profiled element, comprising the steps of:
preparing a plurality of extruders that are operably connected with an extrusion head, the plurality of extruders including at least one Archimedean-screw extruder and at least one positive-displacement extruder;
feeding multiple elastomer compounds to an extrusion head with the plurality of extruders; and
wherein between 2 and 25% of a total volumetric throughput of the multiple elastomer compounds in the elastomer head is delivered to the extrusion head by the at least Archimedian-screw extruder and the remainder of the total volumetric throughput is delivered to the extrusion head by the at least one positive-displacement extruder.

2. The method as set forth in claim 1, wherein the at least one Archimedean-screw extruder feeds an elastomer compound that includes both natural and synthetic rubbers.

3. The method as set forth in claim 2, wherein the at least one Archimedean-screw extruder includes two Archimedean-screw extruders,
wherein a first Archimedean-screw extruder of the two Archimedean-screw extruders feeds an elastomer compound that contains between 20% and 80% natural rubber, and
wherein a second Archimedean-screw extruders of the two Archimedean-screw extruders feeds an elastomer compound that includes a mixture of natural and synthetic rubbers and carbon black.

4. The method as set forth in claim 3, wherein the at least one positive-displacement extruder includes four positive-displacement extruders that all feed different elastomer compounds.

5. The method as set forth in claim 4, wherein a first positive-displacement extruder of the four positive-displacement extruders feeds an elastomer compound that is made 100% of natural rubber.

6. The method as set forth in claim 5, wherein a second positive-displacement extruder of the four positive-displacement extruders feeds an elastomer compound that is made 100% of synthetic rubber.

7. The method as set forth in claim 6, wherein a third positive-displacement extruder of the four positive-displacement extruders feeds an elastomer compound that does not contain silica.

8. The method as set forth in claim 7, wherein a fourth positive-displacement extruder of the four positive-displacement extruders feeds an elastomer compound that includes a mixture of natural and synthetic rubbers.

9. The method as set forth in claim 1, wherein the at least one Archimedean-screw extruder includes a screw with a flight that has a height and a diameter, and wherein the height is less than 0.2 times the diameter of the screw.

10. The method as set forth in claim 9, wherein the screw of the at least one Archimedean-screw extruder has a length that is greater than eight times the diameter of the screw.

11. The method as set forth in claim 1, wherein the at least one positive-displacement extruder is a positive-displacement counter-rotating twin-screw extruder with intermeshing screw flights that have mating profiles.

12. The method as set forth in claim 1, wherein the extrusion head includes a plurality of ducts for distributing the elastomer compounds from the plurality of extruders to an outlet die, and wherein the at least one Archimedean-screw extruder is connected to the outlet die by a first duct of the plurality of ducts and the at least one positive-displacement extruder is connected to the outlet die by a second duct, and wherein the first duct has a length that is less than the second duct.

13. The method as set forth in claim 12, wherein the plurality of ducts extend in a direction that is substantially perpendicular to a direction in which the elastomer compounds enter the extrusion head.

14. The method as set forth in claim 1, wherein the plurality of extruders are arranged on either side of the extrusion head with respect to a plane of symmetry (P) passing through an outlet orifice of the outlet die.

15. The method as set forth in claim 1, wherein the plurality of extruders are connected to the extrusion head directly without any elastomer-compounding transfer ducts positioned between the plurality of extruders and the extrusion head.

16. The method as set forth in claim 1, wherein the at least one Archimedean-screw extruder includes a plurality of Archimedean-screw extruders that are identical to one another and wherein the at least one positive-displacement extruder includes a plurality of positive-displacement extruders that are identical to one another.

17. The method as set forth in claim 1, wherein the extrusion head comprises a collection of several plates that are arranged side-by-side.
